(19) United States
(12) Patent Application Publication
(10) Pub. No.: US 2016/0207152 A1
(43) Pub. Date: Jul. 21, 2016

(54) METHOD FOR PRODUCING A CUTTING BLADE

(71) Applicant: Weber Maschinenbau GmbH Breidenbach, Breidenbach (DE)

(72) Inventor: Gunther Weber, Gross Nemerow (DE)

(21) Appl. No.: 14/915,203

(22) PCT Filed: Jun. 27, 2014
(86) PCT No.: PCT/EP2014/063650

§ 371 Date: Feb. 26, 2016

(30) Foreign Application Priority Data
Aug. 28, 2013 (DE) 10 2013 217 138.2

(51) Int. Cl. B23P 15/40; B26D 1/00

(52) U.S. Cl. CPC B23P 15/40; B26D 1/0006; B26D 2001/0033; B26D 2001/0046; B26D 2001/006

(57) ABSTRACT

The invention relates to a method for producing a cutting blade for a device for cutting food products, especially a high-performance slicer, where a single-piece blank having a basic structure of the cutting blade is produced, and the blank is machined and then separated into at least two segments.

The invention relates to a method of manufacturing a cutting blade as well as to a cutting blade for an apparatus for slicing food products, for example sausage, ham, cheese or the like. The slicing apparatus can in particular be a high-performance slicer. The cutting blade can e.g. be a circular blade or a scythe-like blade.

A single-piece blank is first produced which has a basic structure of the cutting blade. This blank is subsequently machined.

Such manufacturing processes are generally known. The cutting blades produced in these processes, however, have disadvantages in handling since they e.g. have a relatively large weight. This can in particular be disadvantageous on a change of blade. The balancing must also always take place for the total cutting blade.

The manufacture of cutting blades which are easy to handle is, in contrast, associated with high costs, also because the required very high accuracies can only be achieved with a corresponding stiffness.

It is an object of the invention to provide a simple and inexpensive method of manufacturing a cutting blade which is easy to handle or cutting blades which are easy to handle.

The object is satisfied by methods and by an apparatus each having the features of the independent claims.

In accordance with the invention, a separation, in particular a direct separation, of the machined blank into at least two segments takes place.

The cutting blade is thus in particular divided into parts which can be handled separately. A single-piece cutting blade is thus preferably no longer present after the manufacture.

A multi-segmented cutting blade has the result, for example, that the handling is improved and facilitated. The cutting blade thus does not have to be transported as a whole, which is, for example, advantageous on a change of the cutting blade. The total weight of the cutting blade in particular does not have to be moved at once since a separate transport and/or a separated adjustment in the associated mount of the segments is made possible due to the separation.

It is also possible due to the separation of the blank only to replace individual segments. Segments which have a higher wear than other segments can e.g. be exchanged more frequently. Segments having a longer life, in contrast, can remain longer at the slicing apparatus.

The balancing can in particular take place separately for the respective individual segments. Alternatively, a joint balancing of the individual segments is also possible, in particular when the pairing of the segments is to be maintained.

At least one segment can preferably have a counterweight. Due to the reduced weight to be transported of the individual segments, the counterweight can also remain on the segment when the segment is replaced.

With single-piece cutting blades, a remaining of the counterweight is only possible with limitations, if at all, due to the large weight of the cutting blade. The counterweight thus first has to be removed before the cutting blade can be removed from the blade mount.

The counterweight can in particular be fixedly connected to the respective segment. This e.g. has the result that a risk of confusion is excluded since the counterweight is unambiguously associated with one segment.

A releasable counterweight can in particular be arranged completely on a corresponding segment or can also project beyond the segment up to and into the region of an adjacent associated segment.

The blade can in particular be fastened in an innovative manner to a blade mount due to the separate segments. A central clamping is thus possible, for example, so that the segments can in particular be pushed in or inserted from the side, can be fixed to the blade mount and can then be clamped by a clamping apparatus acting in the axial direction.

In accordance with the invention, the blank is machined before it is separated. This has the advantage that conventional machining apparatus, for example, grinding apparatus, can be used. It namely does not play any substantial role during the entire machining that the end product is a segmented cutting blade since the separation only takes place after the machining.

The costs for the manufacture of easily handlable, in particular segmented, cutting blades are thus reduced by the use of conventional machining apparatus.

Since the blank is machined as a whole, the separate segments are ideally matched to one another. The blank is thus in particular left in one piece for as long as possible and is only divided at the end of the production process.

The separation can in this respect generally take place into as many segments as desired. A separation can in particular take place into two, three, four, five or more segments.

That part region of the machined blank of any desired shape can in particular be considered as a segment which is separate from the remaining blank, wherein all the segments together form the cutting blade. The segments of a cutting blade can in particular have the same shape.

Further developments of the invention are set forth in the dependent claims, in the description and in the enclosed drawings.

In accordance with an embodiment, the basic structure of the cutting blade corresponds to a scythe-like blade having exactly one spiral.

The spiral can in particular also be called a scythe or a leaf.

A conventional scythe-like blade having a single spiral can thus e.g. be divided into two segments.

it is also possible to split a circular blade, which by definition has no spiral, into a plurality of segments. The segments can in this respect preferably be of the same construction. With a circular blade having two segments, each segment can thus be formed in the shape of a semicircle, for example.

In an alternative embodiment, the basic structure of the cutting blade corresponds to a scythe-like blade having at least two spirals. Such blades are also called multi-leaf blades or as multi-spiral blades.

The segments can preferably be of the same construction. With a blade having two segments, for example, each of the segments can thus form precisely one half of the cutting blade. The weight is thus in particular halved during the transport since the segments can be moved individually.

In a further development, the separation takes place such that each segment has exactly one spiral. The number of segments in particular corresponds to the number of spirals.

If, for example, one of the spirals has wear phenomena, the corresponding segment can thus be removed and reground, for example.

In accordance with a further embodiment, the production of the blank comprises a cutting out, a stamping out, a milling out and/or a casting process. The blank is in particular cut out of a material carrier. This is possible, for example, by means of a laser beam, a sand jet and/or a water jet or by means of a mechanical separating process. Precise cuts can in particular be made on the use of a laser. The offcuts can therefore in particular be kept low.

The cutting-out apparatus can in particular be moved over the material carrier in a computer-controlled manner. A desired blade shape can preferably be cut out by means of a control. The blade shape can in this respect in particular correspond to the shape of a circular blade or of a scythe-like blade. The scythe-like blades can have one or more spirals.

The geometry of the future cutting blade can in particular thus be completed before the separation into individual segments takes place.

In accordance with a further embodiment, the machining comprises a dishing of the cutting blade, in particular to increase the stiffness. The cutting blade is in this respect machined such that it has, in the widest sense, a shell-like or dish-like shape. The blade body is in particular set back with respect to the cutting plane defined by the cutting edge of the blade on its side facing a produce to be sliced during the cutting operation. It is hereby achieved that compressions of the product to be sliced are largely avoided. This shell shape or dish shape of the blade at one side therefore practically does not influence the product itself during cutting operation. Only the just cut off product slice has to avoid the cutting blade, which is, however, not problematic due to its easier deformability.

In accordance with a further embodiment, the machining comprises a grinding of at least one blade edge of the cutting blade. Each segment preferably has exactly one blade edge which e.g. extends along the associated spiral.

The total blade edge or all blade edges of the cutting blade is/are thus preferably first completely ground before a separation into individual segments takes place. Conventional grinding apparatus can also be used in this manner, which in particular lowers the manufacturing costs.

In accordance with a further embodiment, the machining can comprise a coating, in particular a lacquering, of the cutting blade.

In accordance with a further embodiment, the machining comprises an introduction, preferably a boring, stamping or laser cutting, of at least one cut-out, in particular for fastening, centering and/or positioning the cutting blade at the slicing apparatus or at a machining apparatus, in particular at a grinding apparatus.

Cut-outs are in particular first introduced into the cutting blade before the cutting blade is ground.

A plurality of cut-outs are preferably provided. The cut-outs can be formed as round, in particular as holes. Each segment preferably has at least one cut-out. A plurality of cut-outs are particularly preferably provided per segment. The cut-outs can also serve for the fastening of one or more counterweights. The cut-outs can furthermore be used to be mounted at a blade guard, i.e. at an apparatus for the transport and/or support of the cutting blade. The cut-outs can also serve for a centering and/or for an unambiguous positioning of the cutting blade. In this manner, the cutting blade can be mounted at an exact position, e.g. at a slicing apparatus and/or at a machining apparatus, in particular at a grinding apparatus.

All the fastening bores and/or centerings are thus in particular first introduced before the cutting blade is divided into segments.

In accordance with a further embodiment, the separation comprises at least one separating cut, in particular by means of a laser beam, sand jet and/or water jet, or by means of a mechanical separating process. It is also conceivable to realize the separation by a breaking apart, for example. A predetermined breaking point can in particular be provided in this respect.

A machined blank can preferably be laser cut into segments by means of a laser. A precise separation is made possible in this manner.

In a further development, the separating cut extends at least sectionally along a straight line. The separating cut can in particular take place centrally, for example when the cutting blade is divided into two identical segments, e.g. each having a spiral.

The separating cut preferably comprises a straight cut since this can in particular be realized simply. The separating cut can, however, generally also have curves, angles or any other line shapes, wherein a positioning or association of the segments as well as a mass balancing can preferably thus be ensured.

In accordance with a further embodiment, the separation takes place after the complete machining of the blank. All the machining steps, in particular a grinding, are consequently in particular completed before the blank is separated into the individual segments. The cutting blade is thus in particular completely finished before it is divided.

It is, however, generally also possible that individual machining steps are still carried out after the separating cut, for example a machining of an edge created by the separating cut.

The cutting blade can in particular first be produced in accordance with a conventional manufacturing process. The machining can also take place in a conventional manner. Innovative machining tools are thus not required. The cutting blade only has to be separated into segments at the end.

In this manner, cutting blades can be manufactured in a simple and inexpensive manner which are easy to handle and which comprise a plurality of segments.

The invention additionally relates to a method of manufacturing of a cutting blade comprising at least two segments for an apparatus for slicing food products, for example sausage, ham, cheese or the like. The slicing apparatus can in particular be a high-performance slicer. The cutting blade can e.g. be a circular blade or a scythe-like blade having one or more spirals.

In accordance with the invention, individual segments are produced separately from a common material carrier, with at least one segment preferably having a spiral.

The cutting blade can in particular be a multi-leaf blade or a multi-spiral blade. Each segment can preferably have at least one spiral.

It is, however, also possible that the cutting blade is formed as a scythe-like blade having only one single spiral. In this case, only one segment has the spiral.

The segments are clamped onto a preferably common clamping apparatus, with the segments in particular being clamped in a planar manner with respect to one another. The segments can be mounted on the clamping apparatus, for example, by means of a screwing apparatus, latching apparatus and/or clamping apparatus. A central clamping is thus possible, for example, in which the segments are clamped laterally and are fixed at the clamping apparatus.

The clamping apparatus at least primarily serves for the holding of the segments during the machining.

The segments are subsequently machined on the clamping apparatus. The machining of the segments can preferably take place jointly, i.e. while the segments are jointly clamped. The segments can in particular be machined, e.g. dished and/or ground, simultaneously. The individual segments can be ideally matched to one another by this uniform machining.

It is, however, alternatively also possible to machine the individual segments separately, in particular consecutively or spaced apart from one another.

On the grinding of conventional scythe-like blades, there is, for example, the disadvantage that the whole peripheral region cannot be ground. A so-called run-out region, which cannot be reached by a grinding device, is thus e.g. provided in the vicinity of an edge of the spiral which does not serve as a cutting region.

Such a run-out region can be omitted on a separate machining of the segments since the segments can be ground independently of one another. Cutting regions of 360° are thus possible. The cutting region can also be larger than 360° depending on the geometry of the segments.

A blade edge can in particular extend along one or each spiral.

An independent grinding of the individual segments additionally has the advantage that the individual segments can be ground using different blade parameters, in particular blade angles.

The blade angle is that angle which a planar surface, which will also be called a blade surface in the following, which is located at the radially outer periphery of the cutting blade and whose radially outwardly disposed end is formed by the cutting edge, includes with the cutting plane extending perpendicular to the axis of rotation of the blade. The magnitude of the blade angle, that is the steepness of the blade surface, determines the influencing of the product to be sliced, on the one hand, and the manner of the placing of the respectively cut off product slice by the cutting blade, on the other hand.

In practice, the magnitude of the blade angle is selected in dependence on the specific product and application circumstances. A blade angle, which is constant along the cutting edge, in this respect always represents a compromise with respect to the respective products to be sliced. Too large a blade angle, i.e. too steep a blade surface, must be avoided where possible since too great a pressure is hereby exerted onto the product and the product could thus be exposed to no longer acceptable compressions, A small blade angle, in contrast, i.e. a relatively flat-set blade surface, produces gentle, soft cuts which do not compress the product unnecessarily. However, with such a flat-set cutting blade, the placing behavior with respect to the respective cut off product slices which is desired in most cases cannot be achieved. The product slices can in particular not be “slid off” in the actually desired manner using a cutting blade set too flat.

Depending on the region at which the cutting blade enters into the product, the blade angle of a segment can be selected as larger or smaller. With a segment at which the cutting blade enters into the product, the blade angle can thus preferably be selected smaller than in the region of the projecting spiral. The blade angle there can in particular be selected larger to allow a better placement of the cut-off product slices.

The individual segments can each have constant blade angles. Alternatively, variable blade angles, in particular constantly increasing or decreasing blade angles, of the individual segments are also possible.

If the individual segments are produced separately from a common material carrier, the individual segments can each be oriented as desired on the material carrier. The available material can thus, for example, be ideally utilized. This can in particular result in a cost saving in the manufacturing of cutting blades having a plurality of segments.

In accordance with an embodiment, the production of the segments comprises a cutting out, in particular a laser cutting, a stamping out and/or a milling out. A cutting out by means of a sand jet or water jet is also possible.

The individual segments can thus in particular be cut out of exactly one material carrier.

The production of the segments can preferably be optimized, in particular by an arrangement of the segments on the material carrier, such that offcuts of the material carrier are kept small. A control can in particular be provided for this purpose.

A detection device, e.g. an optical detection device, can preferably be provided which detects the dimensions of the material carrier. The position of the individual segments in which the offcuts of the material carrier are kept the lowest overall can e.g. subsequently be calculated by means of a calculating unit. The segments can subsequently in particular be cut out with reference to the calculations.

The available material carrier is thus utilized to best effect. The material costs can be considerably reduced by the reduced offcuts.

In accordance with a further embodiment, the production is carried out such that the segments have oppositely disposed orientations on the material carrier. The in particular substantially D-shaped segments can thus be cut out of the material carrier alternately rotated with respect to one another. The individual segments can in particular be positioned such that the blade regions border one another at least in part. The edges of the segments not available for cutting, which are in particular straight, can preferably be oriented in parallel with one another. There is thus a comparatively small remainder in the manufacture of the individual segments.

In accordance with a further embodiment, the machining comprises a dishing of the cutting blade, a grinding of at least one cutting edge of the cutting blade and/or an introduction, preferably a boring, stamping or laser cutting, of at least one cut-out, in particular for fastening the cutting blade to the slicing apparatus. A plurality of cut-outs can preferably also be provided. Each segment can in particular have at least one cut-out.

The cut-outs can in particular be formed as round, e.g. as holes, and can, for example, serve for the fastening of the cutting blade to a blade shaft. Alternatively or additionally, cut-outs are possible for the fastening of counterweights and/or of a blade guard.

The dishing and/or the grinding of the individual segments can preferably take place simultaneously and/or together, i.e. while the segments are jointly clamped, in particular to match the segments to one another in a planar manner.

The machining can furthermore comprise a coating, in particular a lacquering, of the segments.

The invention additionally relates to a method of manufacturing a cutting blade comprising at least two segments for an apparatus for slicing food products, in particular for a high-performance slicer, wherein the individual segments are produced from different material carriers. At least one segment preferably has a spiral.

The material carriers are thus configured differently. Segments having different properties, in particular different cutting properties, can thereby be manufactured.

In accordance with a further development, the different material carriers differ with respect to the material and/or with respect to the material thickness.

The segments can in particular be manufactured from different material carriers which comprise different material compositions. The materials can in particular be metals, plastics, ceramics or corresponding mixtures.

The different materials thus allow different cutting parameters or wear parameters. The materials can in particular be selected in dependence on the respective cutting phase.

The segments can in particular be manufactured from material carriers having different material thicknesses. The segments can preferably be of different thicknesses. A balancing of the cutting blade can in particular thereby be carried out.

The invention additionally relates to a cutting blade for an apparatus for slicing food products, in particular for a high-performance slicer, having at least two segments, wherein the segments differ with respect to the material and/or with respect to the material thickness.

A segmented cutting blade is easy to handle since the segments can in particular be transported, mounted and/or dismantled individually.

All the embodiments of the apparatus described here as well as all the embodiments of the methods described here can, where sensible, each be combined with one another.

The invention will be described in the following by way of example with reference to the drawings. There are shown:

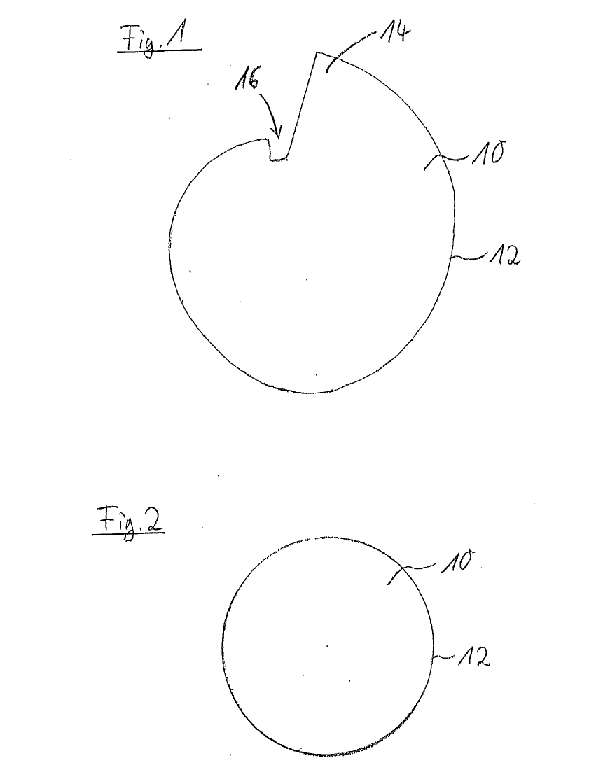

FIG. 1 a front view of a basic structure of a scythe-like blade;

FIG. 2 a front view of a basic structure of a circular blade;

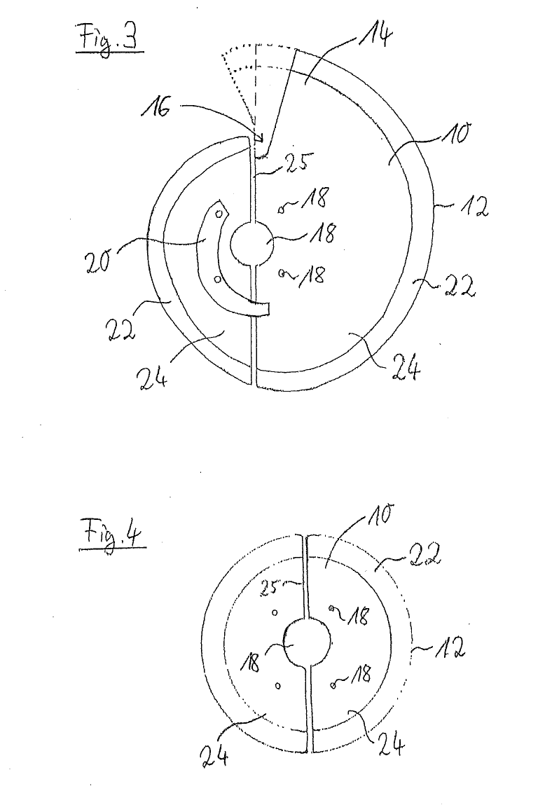

FIG. 3 a front view of a first embodiment of a scythe-like blade manufactured using a method in accordance with the invention;

FIG. 4 a front view of a first embodiment of a circular blade manufactured using a method in accordance with the invention;

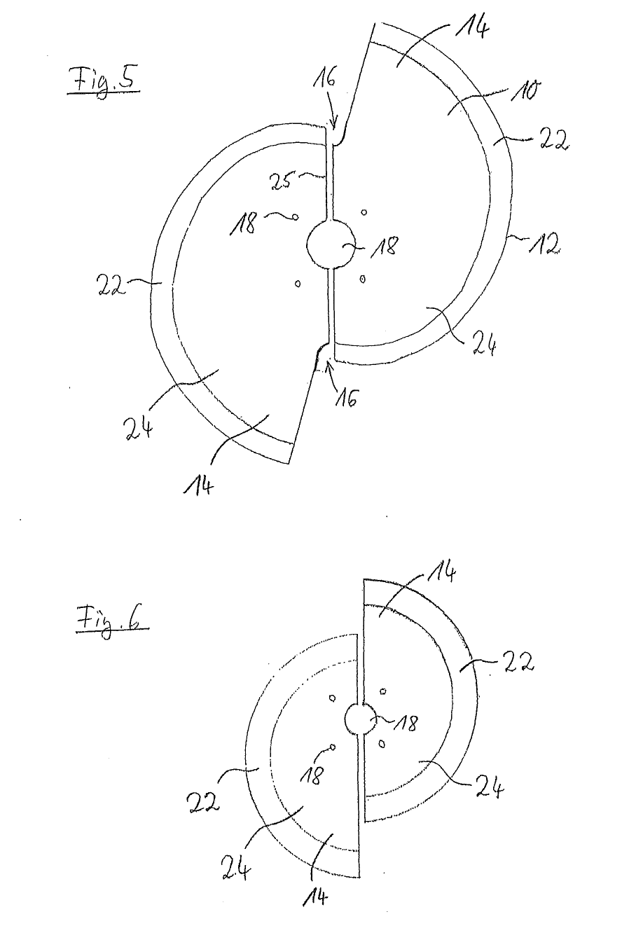

FIG. 5 a front view of a second embodiment of a scythe-like blade manufactured using a method in accordance with the invention;

FIG. 6 a front view of a third embodiment of a scythe-like blade manufactured using a method in accordance with the invention;

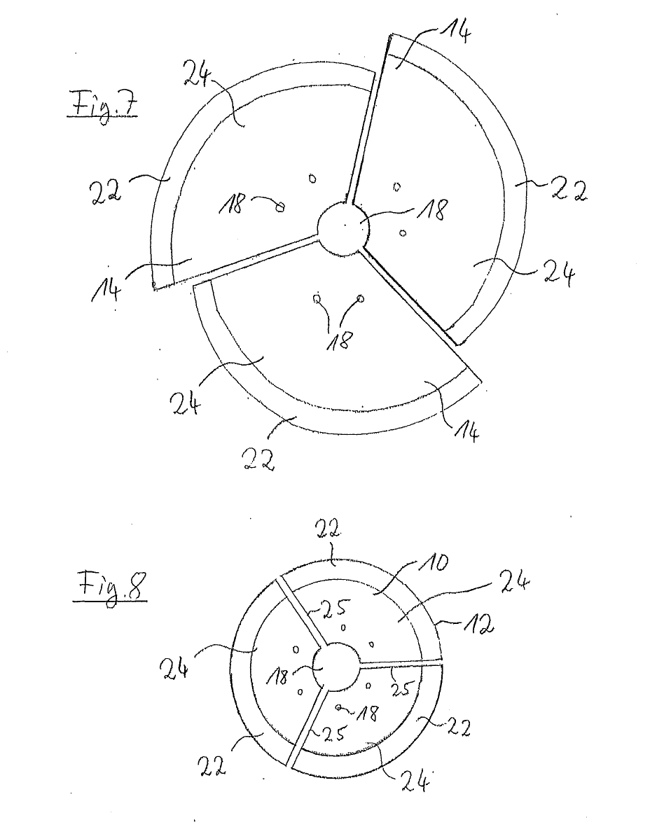

FIG. 7 a front view of a fourth embodiment of a scythe-like blade manufactured using a method in accordance with the invention;

FIG. 8 a front view of a second embodiment of a circular blade manufactured using a method in accordance with the invention;

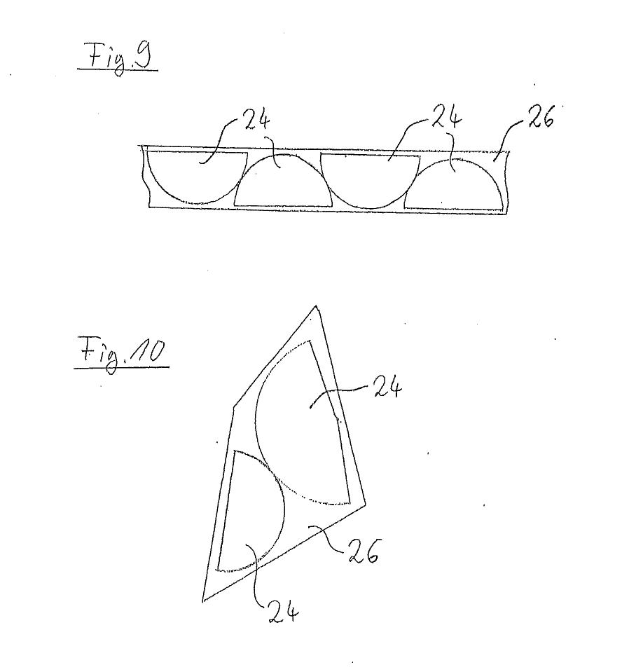

FIG. 9 a plan view of segments distributed over a first material carrier; and

FIG. 10 a plan view of segments distributed over a second material carrier.

FIG. 1 shows a blank 10 which has a basic structure 12 which corresponds to a scythe-like blade having a spiral 14.

The blank 10 additionally has a run-out 16.

In accordance with the invention, the blank 10 is produced in one piece and is, for example, laser cut out of a material carrier.

A blank 10 is shown in FIG. 2. The basic structure 12 of the blank 10 in this respect corresponds to a circular blade.

This blank 10 can also be produced, for example laser cut, in one piece from a material carrier.

The blank 10 in accordance with FIG. 1 has been subjected to various machining steps in FIG. 3. Cut-outs 18 were thus, for example, introduced into the blank 10.

The cut-outs 18 can, for example, serve for the mounting and/or for the centration at a blade mount. A counterweight 20 can also be attached to the cut-outs 18, for example.

The blank 10 additionally has a blade edge 22. After the machining, the blank 10 can be separated into two segments 24 each having a blade edge 22. The separation takes place by means of a separating cut along a straight line 25.

Alternatively, the segments 24 can already be produced separately from one another during the manufacture.

A run-out 16 is in this respect no longer required for the grinding. Blade edges 22 can thus also be produced which have larger peripheral lengths. A cutting region of 360° is shown by dashed lines in this respect in FIG. 1. A cutting region of more than 360° is shown by dotted lines.

The shape of the spiral 14 is shown purely by way of example. Any desired shapes of the spiral 14 are generally possible.

The blade edge 22 of the segment 24 shown at the left can in this respect have a different blade angle, e.g. a more acute blade angle, than the blade edge 22 of the segment 24 shown at the right which comprises the spiral 14.

After the grinding, the counterweight 20 can be mounted to a segment 24. The counterweight 20 in this respect projects beyond the segment 24 at which it is mounted in an exemplary variant.

FIG. 4 corresponds to the blank 10 in accordance with FIG. 2 which was divided into two segments 24 after the machining. The machining can take place analogously to the methods described in connection with FIG. 3.

Respective scythe-like blades, which comprise two segments 24, are shown in FIG. 5 and FIG. 6. Each of the segments 24 in this respect has a spiral 14.

The segments 24 In accordance with FIG. 6 are in particular manufactured separately since no run-out 16 is provided. A cutting region of 360° is made possible by a separate grinding of the segments 24.

A scythe-like blade having three segments 24 is shown in FIG. 7. Each segment 24 in this respect has a spiral 14.

A circular blade having three segments 24 is shown in FIG. 8. A single-piece blank can in this respect first be produced and machined. The separation into three segments 24 can subsequently take place with the aid of three separating cuts along the lines 25. Alternatively, the individual segments 24 can also be manufactured separately and subsequently machined.

A material carrier 26 is shown in FIG. 9. D-shaped segments 24 can be cut out of the material carrier 26 individually in a space-saving manner. The D-shaped segments 24 are in this respect oriented oppositely to one another.

The ideal positions of the segments 24 can be determined by means of a detection device, not shown, as well as by means of a calculating unit. The segments 24 can subsequently be cut-out of the material carrier 26 and machined.

A further material carrier 26 is shown in FIG. 10 out of which two segments 24 can be cut, with the offcuts being kept as small as possible.

Cutting blades which are simple to handle and which comprise a plurality of segments can thus be manufactured in a simple and inexpensive manner by the method in accordance with the invention.

### REFERENCE NUMERAL LIST

10 blank

12 basic structure

14 spiral

16 run-out

18 cut-out

20 counterweight

22 blade edge

24 segment

25 line

26 material carrier

1-18. (canceled)

19. A method of manufacturing a cutting blade for an apparatus for slicing food products, comprising the steps of:
producing a single-piece blank having a basic structure of the cutting blade;
machining the blank; and
separating the machined blank into at least two segments.

20. The method in accordance with claim 19, wherein the basic structure of the cutting blade corresponds to a scythe-like blade having exactly one spiral.

21. The method in accordance with claim 19, wherein the basic structure of the cutting blade corresponds to a scythe-like blade having at least two spirals.

22. The method in accordance with claim 21, wherein the separation takes place such that each segment has exactly one spiral.

23. The method in accordance with claim 19, wherein the step of producing the blank comprises a cutting out.

24. The method in accordance with claim 19, wherein the step of machining comprises a dishing of the cutting blade.

25. The method in accordance with claim 19, wherein the step of machining comprises a grinding of at least one blade edge of the cutting blade.

26. The method in accordance with claim 19, wherein the step of machining comprises an introduction of at least one cut-out.

27. The method in accordance with claim 19, wherein the step of separation comprises at least one separating cut.

28. The method in accordance with claim 27, in which the separating cut extends at least sectionally along a straight line.

29. The method in accordance with claim 19, wherein the step of separation takes place after the complete machining of the blank.

30. A method of manufacturing a cutting blade comprising at least two segments for an apparatus for slicing food products, comprising the steps of:
separately producing the individual segments from a common material carrier;
clamping the segments onto a clamping apparatus; and
machining the segments on the clamping apparatus.

31. The method in accordance with claim 30, wherein the segments are clamped using a common clamping apparatus.

32. The method in accordance with claim 30, wherein the segments are clamped in a planar manner with respect to one another.

33. The method in accordance with claim 30, wherein the step of producing of the segments comprises a cutting out.

34. The method in accordance with claim 30, wherein the step of producing is carried out such that the segments have oppositely disposed orientations on the material carrier.

35. The method in accordance with claim 30, wherein the step of machining comprises a dishing of the cutting blade, a grinding of at least one blade edge of the cutting blade and/or an introduction of at least one cut-out.

36. A method of manufacturing a cutting blade comprising at least two segments for an apparatus for slicing food products, wherein the individual segments are produced from different material carriers.

37. The method in accordance with claim 36, wherein the different material carriers differ with respect to the material and/or with respect to the material thickness.

38. A cutting blade for an apparatus for slicing food products having at least two segments, wherein the segments differ with respect to the material and/or with respect to the material thickness.
